(19) United States
(12) Patent Application Publication
(10) Pub. No.: US 2016/0205894 A1
(43) Pub. Date: Jul. 21, 2016

(54) COLLAR FOR WILD ANIMAL AND APPARATUS FOR MONITORING/MANAGING ACTIVITY OF WILD ANIMAL USING SAME

(71) Applicant: Electronics and Telecommunications Research Institute, Daejeon (KR)

(72) Inventors: Nae-Soo KIM, Daejeon (KR); Jae-Hong RYU, Sejong (KR); Kye-Seon LEE, Daejeon (KR)

(21) Appl. No.: 14/684,562

(22) Filed: Apr. 13, 2015

(30) Foreign Application Priority Data
Jan. 20, 2015 (KR) 10-2015-0009135

(51) Int. Cl. A01K 11/00; G08C 17/02; A01K 29/00

(52) U.S. Cl. CPC A01K 11/008; A01K 29/005; G08C 17/02

(57) ABSTRACT

A collar for a wild animal and an apparatus for monitoring/managing the activity of a wild animal are disclosed. The present invention discloses a collar for a wild animal that is capable of collecting the location, habitat, activity environment and activity state information of a wild animal and transmitting the collected information to a remote server. The present invention discloses an apparatus for monitoring/managing the activity of a wild animal that is capable of remotely receiving the location, habitat, activity environment and activity state information of a wild animal measured by a collar for a wild animal, and analyzing and managing the habitat environment and activity state of the wild animal. The collar for a wild animal is capable of being continuously operated for a long period performing operation using energy that can be acquired from an area around a wild animal and at low power.

### CROSS-REFERENCE TO RELATED APPLICATION

This application claims the benefit of Korean Patent Application No. 10-2015-0009135, filed Jan. 20, 2015, which is hereby incorporated by reference herein in its entirety.

### BACKGROUND

1. Technical Field

The present disclosure relates generally to a collar for a wild animal and an apparatus for monitoring/managing the activity of a wild animal using the same and, more particularly, to a collar capable of collecting information enabling the determination of the wild habitat environment and activity state of an animal that is living in a wild area, such as a forest, and an apparatus capable of determining, managing and operating the habitat environment and activity state of a wild animal using the collar from a remote location.

2. Description of the Related Art

So far, the collection of information about a wild animal that is living in an outdoor area, such as a forest, has focused on the determination of a location.

In order to determine the location of an animal, a terminal capable of identifying a location is chiefly attached to a collar for a wild animal. Conventionally, a remote radio measuring technique that tracks the location of an animal equipped with a radio transmitter using a directional antenna has been used. However, this method is disadvantageous in that the accuracy of the tracking of the location of an animal is low, it is difficult in a bad weather condition or at night to perform tracking, and a lot of time and effort are required to track the location of an animal in a mountainous area inaccessible to humans.

Accordingly, recently, a method using a global positioning system (GPS) and a third-generation (3G) mobile communication modem has been used to enable precise and remote tracking. However, this method is disadvantageous in that a large amount of battery power is consumed (in particular, a 3G modem consumes a considerably larger amount of power than a GPS reception module) and this method can be used only for a few months, so that continuous location tracking cannot be achieved and thus a long-term movement state throughout each season cannot be determined.

Furthermore, a collar for a wild animal is generally equipped with a sufficiently high-capacity battery because it is difficult to separate the collar for a wild animal from an animal and attach it to the animal again. Accordingly, the weight or volume of the collar for a wild animal increases, and thus the collar for a wild animal may inconvenience or limit the activity of the animal.

Meanwhile, in order to analyze and determine the various activity states of a wild animal, it is necessary to periodically collect not only the location of the wild animal but also a surrounding environment, such as the temperature, humidity, illuminance, etc. of the habitat in which the wild animal is living, and activity states, such as the posture, movement, speed, etc. of the wild animal. However, most currently used wild animal monitoring collars focus on the determination of a location, and cannot be used to remotely monitor the activity states of a wild animal.

Furthermore, the conventional collar for a wild animal uniformly transmits data in regular periods. Accordingly, the conventional collar for a wild animal is disadvantageous in that flexible operation cannot be performed when a larger amount of data is required to be received in a specific time span and in that the lifespan of a battery is reduced due to high battery consumption when data is uniformly transmitted in the case where there is no change in location or activity, as occurs when a bear is hibernating.

As related technologies, Korean Patent Application Publication No. 2006-0106804 discloses a method and system for managing health using a collar for an animal, and Korean Patent Application Publication No. 2010-0136270 discloses a system and method for tracking the location of an animal.

### SUMMARY

At least one embodiment of the present invention is directed to the provision of a collar for a wild animal that is capable of collecting the location, habitat, activity environment and activity state information of a wild animal and transmitting the collected information to a remote server.

At least one embodiment of the present invention is directed to the provision of an apparatus for monitoring/managing the activity of a wild animal that is capable of remotely receiving the location, habitat, activity environment and activity state information of a wild animal measured by a collar for a wild animal, and analyzing and managing the habitat environment and activity state of the wild animal.

At least one embodiment of the present invention is directed to the provision of a collar for a wild animal that is capable of being continuously operated for a long period using a technique that performs operation using energy that can be acquired from an area around a wild animal and at low power.

In accordance with an aspect of the present invention, there is provided a collar for a wild animal, including: a sensor module unit configured to collect the habitat environment and activity state information of a wild animal; a global positioning system (GPS) receiver configured to collect the location information of the wild animal; a main processor configured to transmit the habitat environment and activity state information and location information of the wild animal to a remote server via a mobile communication module unit, to receive a change control command, regarding the information collection period of the sensor module unit and the GPS receiver and a transmission period for the transmission of the habitat environment and activity state information and location information of the wild animal to the server, via the mobile communication module unit, and to effect a corresponding change; and an energy harvesting power supply/charge module unit configured to supply power to the sensor module unit, the GPS receiver, and the main processor.

The main processor may collect the habitat environment and activity state information and location information of the wild animal in accordance with a set period value, may store the habitat environment and activity state information and location information of the wild animal in internal memory, and may periodically transmit the information stored in the memory to the remote server via the mobile communication module unit as wild animal activity monitoring information.

The GPS receiver, the sensor module unit, and the mobile communication module unit may be maintained in an Off state in an initial operation stage, and only the main processor may be operated in the initial operation stage.

The main processor may check a wild animal activity information collection period in the initial operation stage.

When a preset wild animal activity information collection time has been reached while the main processor is checking the wild animal activity information collection period, the main processor may collect the habitat environment and activity state information and the location information by turning on the power of the GPS receiver and the sensor module unit, and may store the collected information in the memory.

When the storage in the memory has been completed, the main processor may minimize power consumption by turning off power of the GPS receiver and the sensor module unit.

When a wild animal activity information transmission time has been reached, the main processor may turn on the power of the mobile communication module unit, and may transmit the data stored in the memory to the remote server via the mobile communication module unit.

When the transmission of the data stored in the memory has been completed, the main processor may switch the mobile communication module unit to reception mode, and may wait for a given period of time in order to receive a control command from the remote server.

The energy harvesting power supply/charge module unit may include: a direct current (DC)/DC booster/charger configured to boost solar thermal energy and vibration energy attributable to the movement of the wild animal input via a solar panel and a piezoelectric element; a secondary battery configured to store the energy boosted by the DC/DC booster/charger; and a super capacitor configured to accumulate and charge the vibration energy.

The sensor module unit may include a temperature/humidity sensor, a three-axis acceleration sensor, and an illuminance sensor.

In accordance with another aspect of the present invention, there is provided an apparatus for monitoring/managing activity of a wild animal, including: a data transmission and reception unit configured to receive the habitat environment and activity state information and location information of a wild animal from a collar for a wild animal, and to transmit control data adapted to control the information collection and transmission periods of the collar for a wild animal to the collar for a wild animal; a wild animal activity pattern comparison and analysis unit configured to analyze the habitat environment and activity state information and location information of the wild animal by comparing them with the previously stored activity patterns of the corresponding wild animal; and a control unit configured to store the habitat environment and activity state information and location information of the wild animal, received by the data transmission and reception unit, in a database, to generate the control data based on the result of the analysis from the wild animal activity pattern comparison and analysis unit, and to transmit the generated control data to the collar for a wild animal via the data transmission and reception unit.

The control unit may store the result of the analysis of the wild animal activity pattern comparison and analysis unit in the database.

When the result of the analysis of the wild animal activity pattern comparison and analysis unit corresponds to a first abnormal state, the control unit may set the information collection and transmission periods of the collar for a wild animal to a shorter value than previous information collection and transmission periods.

The first abnormal state may correspond to a case where a measured habitat environment, activity state location are abruptly changed.

When the result of the analysis of the wild animal activity pattern comparison and analysis unit corresponds to a second abnormal state, the control unit may set the information collection and transmission periods of the collar for a wild animal to a longer value than previous information collection and transmission periods.

The second abnormal state may correspond to a case where a measured habitat environment, activity state and location are maintained in a constant state without change.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic configuration diagram of a system for monitoring the activity of a wild animal according to an embodiment of the present invention;

FIG. 2 is a block diagram of a system for monitoring the activity of a wild animal according to an embodiment of the present invention;

FIGS. 3 and 4 are flowcharts illustrating a method of operating a collar for a wild animal at low power and the transmission of information according to an embodiment of the present invention;

FIG. 5 is a timing diagram for the transmission of wild animal activity information according to an embodiment of the present invention; and

FIG. 6 is a flowchart illustrating the changing of a wild animal activity monitoring period according to an embodiment of the present invention.

### DETAILED DESCRIPTION

The present invention may be subjected to various modifications and have various embodiments. Specific embodiments are illustrated in the drawings and described in detail below.

However, it should be understood that the present invention is not intended to be limited to these specific embodiments but is intended to encompass all modifications, equivalents and substitutions that fall within the technical spirit and scope of the present invention.

The terms used herein are used merely to describe embodiments, and not to limit the inventive concept. A singular form may include a plural form, unless otherwise defined. The terms, including “comprise,” “includes,” “comprising,” “including” and their derivatives specify the presence of described shapes, numbers, steps, operations, elements, parts, and/or groups thereof, and do not exclude presence or addition of at least one other shapes, numbers, steps, operations, elements, parts, and/or groups thereof.

Unless otherwise defined herein, all terms including technical or scientific terms used herein have the same meanings as commonly understood by those skilled in the art to which the present invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

Embodiments of the present invention are described in greater detail below with reference to the accompanying drawings. In order to facilitate the general understanding of the present invention, like reference numerals are assigned to like components throughout the drawings and redundant descriptions of the like components are omitted.

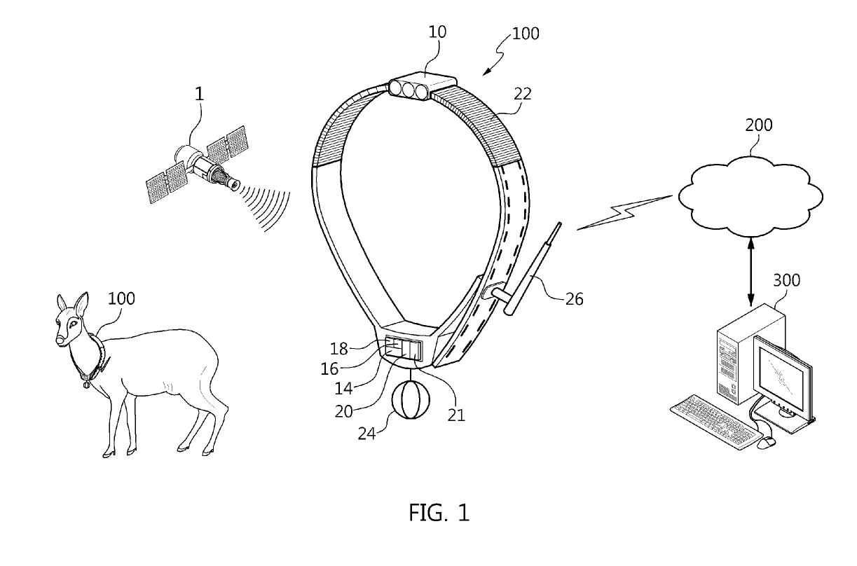

FIG. 1 is a schematic configuration diagram of a system for monitoring the activity of a wild animal according to an embodiment of the present invention.

The system for monitoring the activity of a wild animal according to the present embodiment includes a collar 100 for a wild animal and a server 300 for monitoring/managing the activity of a wild animal. The server 300 for monitoring/managing the activity of a wild animal, which is illustrated in FIG. 1, may be an apparatus for monitoring/managing the activity of a wild animal, which is described in the claims of the present invention.

The collar 100 for a wild animal is directly worn around the neck or the like of a wild animal, acquires information about a habitat environment in which the wild animal is living and the activity state of the wild animal, and transmits the acquired information to the server 300 for monitoring/managing the activity of a wild animal over a wired/wireless communication network (for example, a 3G or WCDMA mobile communication network) 200. Furthermore, the collar 100 for a wild animal may transmit the location information of the corresponding wild animal based on a GPS to the server 300 for monitoring/managing the activity of a wild animal over the 3G or WCDMA mobile communication network 200.

The collar 100 for a wild animal is configured to be supplied with energy harvesting-based power so that the collar 100 for a wild animal can be continuously operated during a long period. The collar 100 for a wild animal includes a GPS receiver 18, a 3G/WDCMA mobile communication module unit 16, and a sensor module unit 10. Since the GPS receiver 18, the 3G/WDCMA mobile communication module unit 16 and the sensor module unit 10 are not operated, power supply thereto is shut off, and thus power consumption is minimized

The server 300 for monitoring/managing the activity of a wild animal may display and analyze the various types of activity information of the wild animal transmitted from the collar 100 for a wild animal, and may provide the result of the analysis.

Furthermore, the server 300 for monitoring/managing the activity of a wild animal may perform the function of determining the current state of the wild animal based on the collected location information and the activity state information and performing control in order to change the information collection and transmission periods of the collar 100 for a wild animal.

In FIG. 1, reference symbol 1 denotes a GPS satellite, reference symbol 14 denotes a main processor, reference symbol 20 denotes an energy harvesting power supply/charge module unit, reference symbol 21 denotes a secondary battery, reference symbol 22 denotes a solar panel, and reference symbol 26 denotes an antenna.

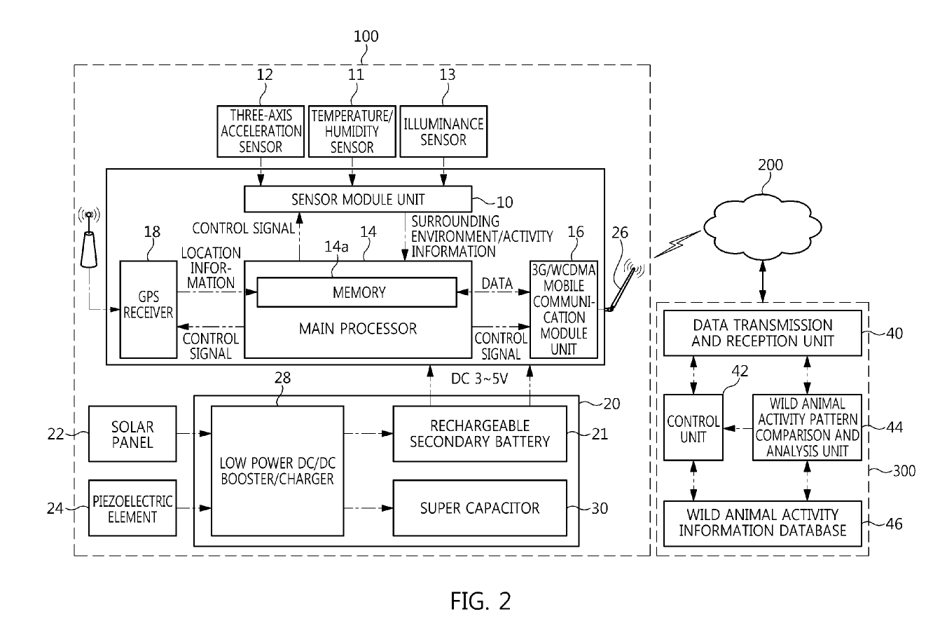

FIG. 2 is a block diagram of a system for monitoring the activity of a wild animal according to an embodiment of the present invention.

A collar 100 for a wild animal includes a sensor module unit 10, a main processor 14, a 3G/WCDMA mobile communication module unit 16, a GPS receiver 18, and an energy harvesting power supply/charge module unit 20. Furthermore, the collar 100 for a wild animal may include a solar panel 22, a piezoelectric energy collection device (for example, a piezoelectric element 24), and an antenna 26.

The sensor module unit 10 may periodically collect the activity state of a wild animal. For this purpose, the sensor module unit 10 includes a temperature/humidity sensor 11 and an illuminance sensor 13 configured to measure a habitat environment in which the wild animal is living and three-axis acceleration sensor 12 configured to measure an activity state, such as the direction of the movement, leaping, running speed, etc. of the wild animal.

The main processor MCU 14 performs the function of periodically collecting habitat environment and activity state information using the sensor module unit 10 and location information using the GPS receiver 18 in accordance with a period value set as a parameter and then storing the collected information in the memory 14a. The information (i.e., the habitat environment and activity state information, location information etc. of the wild animal) stored in the memory 14a as described above may be referred to as wild animal activity monitoring information.

Furthermore, the main processor 14 periodically transmits the wild animal activity monitoring information stored in the memory 14a to the server 300 for monitoring/managing the activity of a wild animal via the 3G/WCDA mobile communication module unit 16.

Moreover, the main processor 14 may perform the control function of effecting a change when receiving a change command related to the information collection period of the sensor module unit 10, the location information collection period of the GPS receiver 18 and the transmission period of the collected information of the memory 14a to the server from a server 300 for monitoring/managing the activity of a wild animal.

The GPS receiver 18 performs the function of periodically collecting the location information of the wild animal under the control of the main processor 14 and then storing the collected information in the memory 14a of the main processor 14.

The 3G/WCDMA mobile communication module unit 16 periodically transmits the wild animal activity monitoring information stored in the memory 14a to the server 300 for monitoring/managing the activity of a wild animal under the control of the main processor 14.

Furthermore, the 3G/WCDMA mobile communication module unit 16 receives various types of control commands from the server 300 for monitoring/managing the activity of a wild animal, and transfers them to the main processor 14.

The energy harvesting power supply/charge module unit 20 supplies required power in order to perform wild animal activity monitoring for a long period. For this purpose, the energy harvesting power supply/charge module unit 20 includes a low power DC/DC booster/charger 28, a rechargeable secondary battery 21, and a super capacitor 30.

In general, since the GPS receiver 18 and the 3G/WCDMA mobile communication module unit 16 consumes a large amount of power, only a general battery cannot help limiting wild animal activity monitoring to a few months. For this purpose, the present invention is configured to convert solar thermal energy and vibration energy related to the movement of a wild animal, acquired from the wild animal and surroundings using the solar panel 22 and the piezoelectric element 24, using the low power DC/DC booster/charger 28 and to continuously store resulting energy in the secondary battery 21. Since the amount of vibration energy acquired by the piezoelectric element 24 is smaller than that of solar thermal energy, the vibration energy is primarily accumulated for a long period by the super capacitor 30 and then charged and used. Since the solar panel 22 must be worn around the neck of a wild animal, a film-type solar panel that can be bent in a curved form is used as the solar panel 22. The piezoelectric element 24 may be configured to be attached in a curved wave acoustic wave structure and a bell form so that it can acquire vibration energy attributable to the up, down, left or right movement of the animal.

The server 300 for monitoring/managing the activity of a wild animal may display and database various types of activity information of the wild animal transmitted from the collar 100 for a wild animal.

Furthermore, the server 300 for monitoring/managing the activity of a wild animal analyzes the location information and the actual activity state information collected from the sensors of the collar 100 for a wild animal by comparing them with the activity patterns of the wild animal, and then performs a control function when required in order to control the information collection and transmission periods of the collar 100 for a wild animal. That is, when a larger amount of data on the activity state of the wild animal is required to be received in a specific time span, the server 300 for monitoring/managing the activity of a wild animal may flexibly control the information collection and transmission periods. For example, when there is no change in the location or activity of an animal during hibernation, as in the case of a bear, the server 300 for monitoring/managing the activity of a wild animal minimizes battery consumption by increasing the information collection and transmission periods, thereby actually increasing the operation lifespan of the collar for a wild animal.

Accordingly, the server 300 for monitoring/managing the activity of a wild animal includes a data transmission and reception unit 40, a control unit 42, a wild animal activity pattern comparison and analysis unit 44, and a wild animal activity information database 46.

The data transmission and reception unit 40 may receive various types of activity information (for example, including location information, habitat environment information, and activity state information) of the wild animal transmitted from the collar 100 for a wild animal.

Furthermore, the data transmission and reception unit 40 may transmit control data adapted to control the information collection and transmission periods of the collar 100 for a wild animal to the collar 100 for a wild animal.

The wild animal activity pattern comparison and analysis unit 44 may analyze the location information and actual activity state information of the wild animal received from the collar 100 for a wild animal by comparing them with the previously stored activity patterns of the wild animal.

Furthermore, the wild animal activity pattern comparison and analysis unit 44 may output the result of the analysis.

The control unit 42 may store the various types of activity information of the wild animal transmitted from the collar 100 for a wild animal in the wild animal activity information database 46. When required, the control unit 42 may also store the result of the analysis, obtained by the wild animal activity pattern comparison and analysis unit 44, in the wild animal activity information database 46.

Furthermore, the control unit 42 may transmit a control signal adapted to control the information collection and transmission periods of the collar 100 for a wild animal to the collar 100 for a wild animal via the data transmission and reception unit 40 based on the result of the analysis received from the wild animal activity pattern comparison and analysis unit 44.

The wild animal activity information database 46 stores the various types of activity information of the wild animal transmitted from the collar 100 for a wild animal. When required, the wild animal activity information database 46 may store the result of the analysis obtained by the wild animal activity pattern comparison and analysis unit 44.

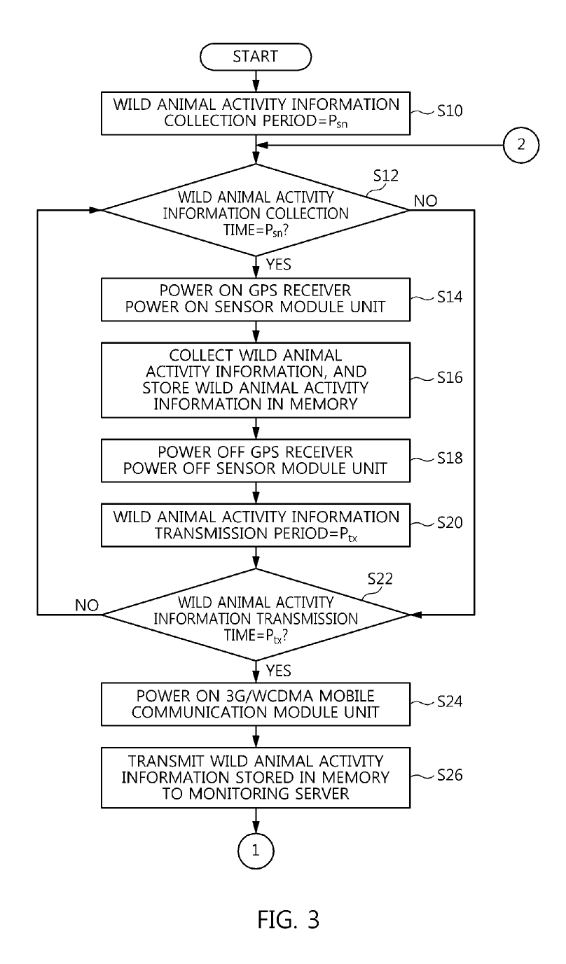

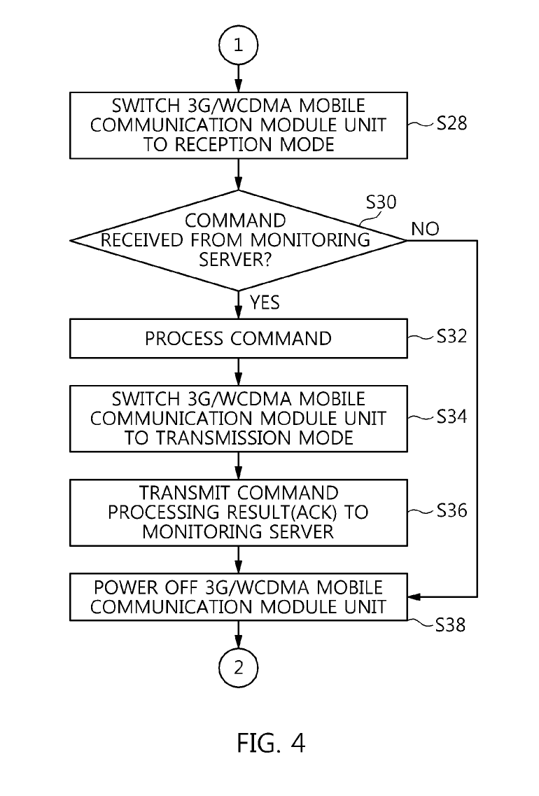

FIGS. 3 and 4 are flowcharts illustrating a method of operating a collar for a wild animal at low power and the transmission of information according to an embodiment of the present invention.

First, in an initial stage, the GPS receiver 18, the sensor module unit 10 and the 3G/WCDMA mobile communication module unit 16 are maintained in an Off state, and only the main processor 14 is operated at low power. In this case, the main processor 14 that operates at low power checks a wild animal activity information collection period Pₛₙ at step S10.

The main processor 14 turns on the power of the GPS receiver 18 and the sensor module unit 10 when the time at which wild animal activity information is collected, which was internally stored as a parameter, has been reached (i.e., wild animal activity information collection time=wild animal activity collection period Pₛₙ) (“Yes” at step S12) while checking the wild animal activity information collection period Pₛₙ at step S14.

Accordingly, the GPS receiver 18 and the sensor module unit 10 are separately operated, collect location information and habitat environment and activity state information, and store them in the memory 14a of the main processor 14 at step S16.

After the storage in the memory 14a, the main processor 14 turns off the power of the GPS receiver 18 and the sensor module unit 10, thereby minimizing power consumption at step S18.

Thereafter, the main processor 14 periodically collects location information and habitat environment and activity state information and continuously stores the information in the memory 14a in accordance with the “wild animal activity information collection Time Pₛₙ” until the “wild animal activity information transmission Time Pₜₓ” is reached at steps S12 to S22.

Furthermore, the main processor 14 turns on the power of the 3G/WCDMA mobile communication module unit 16 when the “wild animal activity information transmission Time Pₜₓ” has been reached (“Yes” at step S22) at step S24.

Thereafter, the main processor 14 transmits the data stored in the memory 14a to the server 300 for monitoring/managing the activity of a wild animal via the 3G/WCDMA mobile communication module unit 16 at step S26.

Thereafter, the main processor 14 switches the 3G/WCDMA mobile communication module unit 16 to reception mode and waits for a given period so that it can receive a control command from the server 300 for monitoring/managing the activity of a wild animal at step S28.

When receiving a control command from the server 300 for monitoring/managing the activity of a wild animal (for example, the collection period Pₛₙ and the transmission period Pₜₓ) (“Yes” at step S30), the main processor 14 processes the related command at step S32.

Thereafter, the main processor 14 switches the 3G/WCDMA mobile communication module unit 16 to transmission mode at step S34, and transmits a command processing result Ack to the server 300 for monitoring/managing the activity of a wild animal at step S36.

Thereafter, the main processor 14 turns off the power of the 3G/WCDMA mobile communication module unit 16, thereby minimizing power consumption at step S38.

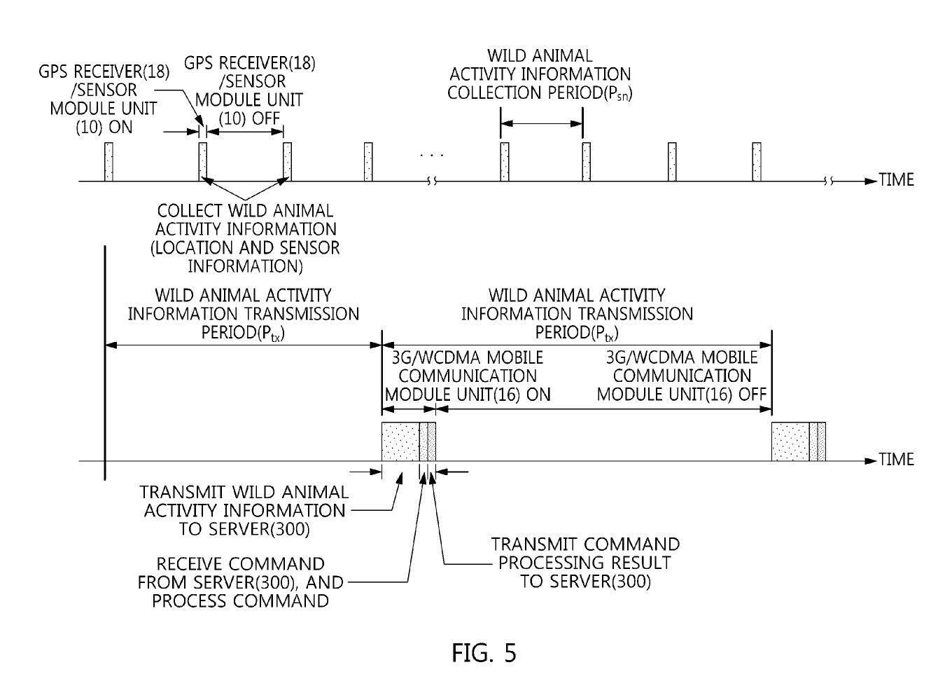

FIG. 5 is a timing diagram for the transmission of wild animal activity information according to an embodiment of the present invention.

The habitat environment and activity state information of the wild animal is collected with period Pₛₙ, and the wild animal activity monitoring information stored in memory 14a is transmitted to the server 300 for monitoring/managing the activity of a wild animal with period Pₜₓ.

In order to minimize the power consumption of the 3G/WCDMA mobile communication module unit 16 that consumes a larger amount of power, the 3G/WCDMA mobile communication module unit 16 is switched to and maintained in reception mode and waits for a short period of time during which a control command can be received from the server 300 for monitoring/managing the activity of a wild animal after transmission to the server 300 for monitoring/managing the activity of a wild animal. Thereafter, when there is a control command, the 3G/WCDMA mobile communication module unit 16 is switched to and maintained in transmission mode for a period during which a result can be received after the processing of the control command and makes an acknowledgement, and then the power of the 3G/WCDMA mobile communication module unit 16 is turned off. That is, operation is performed only in the habitat environment, activity state and location information collection period, the collected information transmission period and the control command reception and response period, and power is turned off or a wait or sleep state is maintained in the remaining period, so that the power consumption of the collar 100 for a wild animal is minimized and thus can be operated for a long period.

Meanwhile, the server 300 for monitoring/managing the activity of a wild animal must transmit a control command for a given period after receiving activity information from the collar 100 for a wild animal when it transmits the control command to the collar 100 for a wild animal, and waits to receive the result of the processing of the control command.

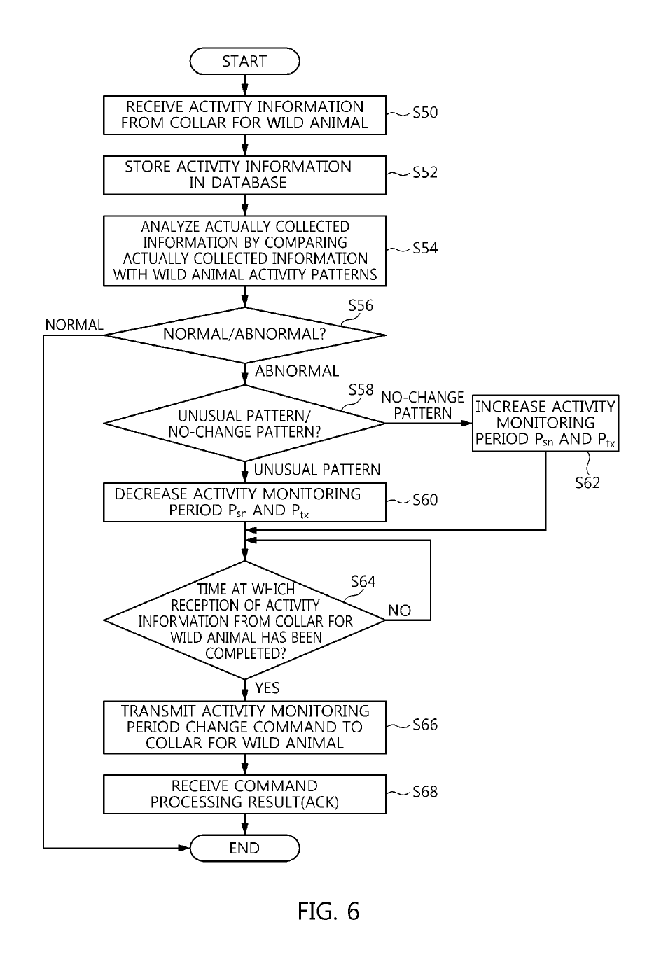

FIG. 6 is a flowchart illustrating the changing of a wild animal activity monitoring period according to an embodiment of the present invention.

First, when receiving data, i.e., activity information, from the collar 100 for a wild animal at step S50, the server 300 for monitoring/managing the activity of a wild animal stores and displays the wild animal activity information in the database 46 at step S52.

Thereafter, the server 300 for monitoring/managing the activity of a wild animal determines whether a state in question is a normal state or an abnormal state by making an analysis by comparing wild animal activity pattern information stored in the server with actual information, i.e., location information, habitat environment information and activity state information, received from the collar 100 for a wild animal at step S54. In this case, the normal state refers to a state in which a corresponding wild animal has performed expected activity. The abnormal state may include an unusual state (an unusual pattern) in which a measured location, a habitat environment or an activity state is abruptly changed, and a no-change state (a no-change pattern) in which a constant state is maintained without change.

If the state is a normal state (“normal” at step S56), it is not necessary to change the wild animal activity monitoring period. In contrast, if the state is an abnormal state (“abnormal” at step S56), the wild animal activity monitoring period must be changed using the method described below.

If the state corresponds to the unusual state of the abnormal state (a “unusual pattern” at step S58), the server 300 for monitoring/managing the activity of a wild animal decreases the wild animal activity monitoring period, i.e., the activity information collection period Pₛₙ and information transmission period Pₜₓ at step S60, thereby allowing a larger amount of information to be collected and also allowing the state of the wild animal to be minutely analyzed and determined.

Meanwhile, if the state corresponds to the no-change state of the abnormal state (a “no-change pattern” at step S58), the server 300 for monitoring/managing the activity of a wild animal determines that the wild animal is staying at a place or is hibernating, and increases the wild animal activity monitoring period, i.e., the activity information collection period Pₛₙ and the information transmission period Pₜₓ at step S62, thereby minimizing the unnecessary power consumption of the collar 100 for a wild animal.

The wild animal activity monitoring period changed as described above is transmitted to the collar 100 for a wild animal at step S66 when the time at which the reception of activity information from the collar 100 for a wild animal has been completed has been reached at step S64. That is, when the time at which the reception of activity information from the collar 100 for a wild animal has been completed has been reached, the server 300 for monitoring/managing the activity of a wild animal transmits a activity monitoring period change command to the collar 100 for a wild animal.

Thereafter, the server 300 for monitoring/managing the activity of a wild animal receives a command processing result Ack from the collar 100 for a wild animal at step S68.

At least one embodiment of the present invention is advantageous in that an environment in which the long-term ecological and activity habits of a wild animal can be determined and researched because not only the location of the wild animal but also the habitat environment, activity state and the like of the wild animal can be continuously and remotely monitored.

At least one embodiment of the present invention is advantageous in that a collar for a wild animal can be semi-permanently operated because energy harvesting-based solar thermal energy and vibration energy attributable to a solar panel and a piezoelectric element is used.

At least one embodiment of the present invention is advantageous in that power consumption can be minimized and the lifespan of a battery can be significantly increased because a GPS receiver, a 3G/WCDMA mobile communication module and a sensor module are operated for only a given period and power is turned off or a waiting state is maintained in the other period.

At least one embodiment of the present invention is advantageous in that a wild animal activity monitoring period can be controlled by a remote server, so that the activity states of a wild animal in various time spans can be determined and analyzed, and so that the consumption of a battery can be minimized by increasing data collection and transmission periods when there has been no change in location and activity for a long period.

As described above, the optimum embodiments have been disclosed in the drawings and the specification. Although the specific terms have been used herein, they have been used merely for the purpose of describing the present invention, but have not been used to restrict their meanings or limit the scope of the present invention set forth in the claims. Accordingly, it will be understood by those having ordinary knowledge in the relevant technical field that various modifications and other equivalent embodiments can be made. Therefore, the true range of protection of the present invention should be defined based on the technical spirit of the attached claims.

What is claimed is:

1. A collar for a wild animal, comprising:
a sensor module unit configured to collect habitat environment and activity state information of a wild animal;
a global positioning system (GPS) receiver configured to collect location information of the wild animal;
a main processor configured to transmit the habitat environment and activity state information and location information of the wild animal to a remote server via a mobile communication module unit, to receive a change control command, regarding an information collection period of the sensor module unit and the GPS receiver and a transmission period for the transmission of the habitat environment and activity state information and location information of the wild animal to the server, via the mobile communication module unit, and to effect a corresponding change; and
an energy harvesting power supply/charge module unit configured to supply power to the sensor module unit, the GPS receiver, and the main processor.

2. The collar for a wild animal of claim 1, wherein the main processor collects the habitat environment and activity state information and location information of the wild animal in accordance with a set period value, stores the habitat environment and activity state information and location information of the wild animal in internal memory, and periodically transmits the information stored in the memory to the remote server via the mobile communication module unit as wild animal activity monitoring information.

3. The collar for a wild animal of claim 2, wherein the GPS receiver, the sensor module unit, and the mobile communication module unit are maintained in an Off state in an initial operation stage, and only the main processor is operated in the initial operation stage.

4. The collar for a wild animal of claim 3, wherein the main processor checks a wild animal activity information collection period in the initial operation stage.

5. The collar for a wild animal of claim 4, wherein, when a preset wild animal activity information collection time has been reached while the main processor is checking the wild animal activity information collection period, the main processor collects the habitat environment and activity state information and the location information by turning on power of the GPS receiver and the sensor module unit, and stores the collected information in the memory.

6. The collar for a wild animal of claim 5, wherein, when the storage in the memory has been completed, the main processor minimizes power consumption by turning off power of the GPS receiver and the sensor module unit.

7. The collar for a wild animal of claim 6, wherein, when a wild animal activity information transmission time has been reached, the main processor turns on power of the mobile communication module unit, and transmits the data stored in the memory to the remote server via the mobile communication module unit.

8. The collar for a wild animal of claim 7, wherein, when the transmission of the data stored in the memory has been completed, the main processor switches the mobile communication module unit to reception mode, and waits for a given period of time in order to receive a control command from the remote server.

9. The collar for a wild animal of claim 1, wherein the energy harvesting power supply/charge module unit comprises:
a direct current (DC)/DC booster/charger configured to boost solar thermal energy and vibration energy attributable to movement of the wild animal input via a solar panel and a piezoelectric element;
a secondary battery configured to store the energy boosted by the DC/DC booster/charger; and
a super capacitor configured to accumulate and charge the vibration energy.

10. The collar for a wild animal of claim 1, wherein the sensor module unit comprises a temperature/humidity sensor, a three-axis acceleration sensor, and an illuminance sensor.

11. An apparatus for monitoring/managing activity of a wild animal, comprising:
a data transmission and reception unit configured to receive habitat environment and activity state information and location information of a wild animal from a collar for a wild animal, and to transmit control data adapted to control information collection and transmission periods of the collar for a wild animal to the collar for a wild animal;
a wild animal activity pattern comparison and analysis unit configured to analyze the habitat environment and activity state information and location information of the wild animal by comparing them with previously stored activity patterns of the corresponding wild animal; and
a control unit configured to store the habitat environment and activity state information and location information of the wild animal, received by the data transmission and reception unit, in a database, to generate the control data based on a result of the analysis from the wild animal activity pattern comparison and analysis unit, and to transmit the generated control data to the collar for a wild animal via the data transmission and reception unit.

12. The apparatus of claim 11, wherein the control unit stores the result of the analysis of the wild animal activity pattern comparison and analysis unit in the database.

13. The apparatus of claim 11, wherein, when the result of the analysis of the wild animal activity pattern comparison and analysis unit corresponds to a first abnormal state, the control unit sets information collection and transmission periods of the collar for a wild animal to a shorter value than previous information collection and transmission periods.

14. The apparatus of claim 13, wherein the first abnormal state corresponds to a case where a measured habitat environment, activity state and location are abruptly changed.

15. The apparatus of claim 11, wherein, when the result of the analysis of the wild animal activity pattern comparison and analysis unit corresponds to a second abnormal state, the control unit sets information collection and transmission periods of the collar for a wild animal to a longer value than previous information collection and transmission periods.

16. The apparatus of claim 15, wherein the second abnormal state corresponds to a case where a measured habitat environment, activity state and location are maintained in a constant state without change.
